(19) United States
(12) Patent Application Publication
(10) Pub. No.: US 2021/0337312 A1
(43) Pub. Date: Oct. 28, 2021

(54) SYSTEMS AND METHODS FOR CREATING IMMERSIVE CYMATIC EXPERIENCES

(71) Applicant: Richard Grillotti, JR., Pasadena, CA (US)

(72) Inventor: Richard Grillotti, JR., Pasadena, CA (US)

(21) Appl. No.: 17/242,146

(22) Filed: Apr. 27, 2021

Related U.S. Application Data
(60) Provisional application No. 63/016,261, filed on Apr. 27, 2020.

(51) Int. Cl. H04R 5/04; G06F 3/01; H04S 7/00; G06F 3/16

(52) U.S. Cl. CPC H04R 5/04; G06F 3/016; G06F 3/165; H04S 7/307; H04S 7/40

(57) ABSTRACT

There is provided a system having a speakers playing an audio having a frequency, a display showing an interference pattern based on the frequency, and a vibrational user interface for providing a tactile experience to a user based on the frequency, the system further comprising a control device including a user control, a non-transitory memory storing an executable code, and a hardware processor executing the executable code to receive an input from the control device and adjust an audio characteristic of the audio in response to the input, adjust a visual characteristic of the interference pattern shown on the display in response to the input, or adjust a vibrational characteristic of the vibrational user interface in response to the input.

### RELATED APPLICATION(S)

The present application claims the benefit of and priority to a U.S. Provisional Patent Application Ser. No. 63/016,261, filed Apr. 27, 2020, which is hereby incorporated by reference in its entirety into the present application.

### BACKGROUND

Sound is an experience typically experienced through hearing. Audio recording and playback techniques have been used for over one-hundred-and-fifty years to capture and replay sounds. These recording and playback techniques focus on the auditory experience of sound and on the frequencies commonly audible to human ears. However, sound is not so limited. As a vibration or compression wave, sound is something that has physical expressions that can be felt and seen, broadening the experience of sound from merely auditory. Sound can be used to create an immersive and even interactive experience.

### SUMMARY

The present disclosure is directed to systems and methods for creating immersive cymatic experiences, substantially as shown in and/or described in connection with at least one of the figures, as set forth more completely in the claims.

The system includes a physical user interface (chair, couch, bed, floor, haptic device or devices attached to or worn by the user), an interference pattern visualization element, a camera, a display, and a speaker. The system is designed to allow a user to hear a sound, experience the physical vibration to feel the sound, and see the effect of the sound on the interference pattern visualization element. In some embodiments, the system may include color elements, such as colored lights or color-changing lights, to further enhance the user's visual experience.

In some implementations, the method for creating immersive cymatic experiences may include a system to receive an input from a user activating the system. The activated system may initiate a physical user interface and, optionally, the speaker. In some implementations, the physical user interface and the speaker will oscillate or vibrate at the same frequency. Activation by the user may also initiate vibration, agitation, or oscillation of the interference pattern visualization element. The interference pattern visualization element may operate at the same frequency as the physical user interface and the speaker. In some embodiments, each element of the system operates at the same frequency of oscillation. In other embodiments, the elements of the system may operate at different frequencies. The different frequencies may be complimentary frequencies, or they may be dissonant frequencies.

In some implementations, the system receives a user input changing the operating frequency of the system. The user input may change the frequency of one or more elements of the system. In some implementations, the system may allow the user to change frequency through a spectrum of operating frequencies such that there is a smooth transition through each frequency across the spectrum. In other implementations, the system may allow the user to change frequencies in a stepwise manner. For example, the user interface for receiving user input changing the operating frequency of the system may be incremented to allow the user to select from a limited number of preset operational frequencies.

In response to the user input, the system may change the frequency of one or more elements of the system. For example, the user may increase the operating frequency of the system. In response to the user input, the system may increase the operating frequency of the physical user interface, the interference pattern visualization element, and the speaker. This change in frequency may be instantaneous or gradual. For example, if the user increased the frequency from 20 hertz (Hz) to 30 Hz, the system may instantaneously change from 20 Hz to 30 Hz, or the change may be a linear increase from 20 Hz to 30 Hz over a time, such as one second or five seconds.

The system then operates at the user-selected frequency. The user may make a subsequent change to the operating frequency of the system. In some embodiments, the user may experience many settings and explore various physical effects, mental effects, and emotional effects of different frequencies.

In some implementations, the system has a pair of speakers playing an audio having a frequency, a display showing an interference pattern based on the frequency, and a vibrational user interface for providing a tactile experience to a user based on the frequency.

In some implementations, the system further comprises a control device including a user control, a non-transitory memory storing an executable code, and a hardware processor executing the executable code to receive an input from the user control and adjust an audio characteristic of the audio in response to the input.

In some implementations, the audio characteristic is one of a fundamental frequency of the audio, a secondary frequency of the audio, a volume of the audio, a beat frequency of the audio, a binaural tone offset of the audio, and a harmonic blending of the audio.

In some implementations, the system further comprises a control device including a user control and a light providing a lighting illuminating an interference medium creating the interference pattern, a non-transitory memory storing an executable code, and a hardware processor executing the executable code to receive an input from the user control and adjust a visual characteristic of the interference pattern displayed on the display in response to the input.

In some implementations, the visual characteristic is one of an intensity of the lighting, a hue of the lighting, and a saturation of the lighting.

In some implementations, the system further comprises a control device including a user control, a non-transitory memory storing an executable code, and a hardware processor executing the executable code to receive an input from the user control and adjust a vibrational characteristic of the vibrational user interface in response to the input.

In some implementations, the vibrational characteristic is one of a fundamental frequency and a secondary frequency.

The present disclosure also includes a method for use with a system including a pair of speakers, an interference visualization element, and a vibrational user interface, the method comprising playing a sound having a frequency through the pair or speaker, displaying an interference pattern based on the frequency of the sound on a display, the interference pattern shown by the interference visualization element, and driving a transducer based on the frequency of the sound to activate the vibrational user interface.

In some implementations, the method further comprised receiving a user input from a control device and adjust one of an audio characteristic of the sound and a vibrational characteristic of the vibrational user interface in response to the input.

In some implementations, the method is used with a system including two or more lights, each light having a corresponding color wherein each of the two or more lights has a different color, the two or more lights lighting the interference visualization element creating a multi-color interference pattern for display on the display.

In some implementations, the method further comprises receiving a user input from a control device and adjusting a visual characteristic of the interference pattern displayed on the display in response to the input.

### BRIEF DESCRIPTION OF THE DRAWINGS

FIG. 1 shows a schematic of an exemplary system for creating immersive cymatic experiences, according to one implementation of the present disclosure;

FIG. 2 shows a diagram depicting an exemplary system for creating immersive cymatic experiences, according to one implementation of the present disclosure;

FIG. 3 shows a diagram depicting another exemplary system for creating immersive cymatic experiences, according to one implementation of the present disclosure;

FIG. 4 shows a diagram depicting an exemplary system for creating immersive cymatic experiences, according to one implementation of the present disclosure;

FIG. 5 shows a diagram depicting another exemplary system for creating immersive cymatic experiences, according to one implementation of the present disclosure;

FIG. 6 shows a diagram depicting another exemplary system for creating immersive cymatic experiences, according to one implementation of the present disclosure; and

FIG. 7 shows a flowchart illustrating an exemplary method of creating immersive cymatic experiences, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

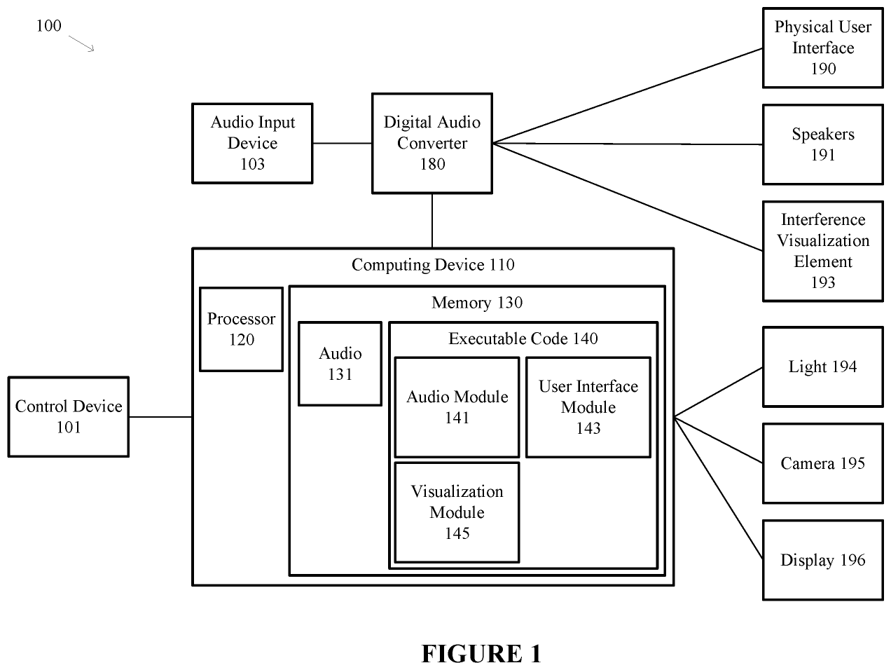

FIG. 1 shows a diagram of a system for animation, according to one implantation of the present disclosure. System 100 includes control device 101, audio input device 103, computing device 110, physical user interface 190, speaker 191, interference visualization element 193, light 194, camera 195, and display 196. Control device 101 may be an input device for receiving user input to adjust various settings of system 100. In some implementations, control device 101 may include adjustment controls, a dial to rotationally adjust a control, slider inputs to linearly adjust a control, a touch-sensitive interface, such as a trackpad or a touch screen, to adjust a control through user touch interaction, or a position/motion detection system where the position or motion of a user's hand, hands, or body is used to adjust a control. User input adjusting settings using control device 101 may adjust an input into system 100, a setting in system 100, or an output of system 100.

Audio input device 103 is a device for providing an audio signal. In some implementations, the audio signal may be an analog audio signal, such as a signal from a microphone recording a singer singing, the sound of an instrument being played or other live audio, or an instrument plugged into a component of system 100. Audio input device 103 may be an audio player such as an audio cassette player, an audio tape player, a record player, or other analog audio player. In other implementations, audio input device 103 may be a digital audio source, such as a digital compact disc player, a digital music player for playing recorded digital music files, such as MPEG-1 Audio Layer III (MP3) files or digital sound files stored in another computer readable format. In some implementations, audio input device 103 may be a laptop computer, a mobile phone, a personal music player, or an internet-connected computer.

Computing device 110 is a computing system for use in creating immersive cymatic experiences in which a user has a multi-sensory experience of an audio signal. As shown in FIG. 1, computing device 110 includes processor 120, and memory 130. Processor 120 is a hardware processor, such as a central processing unit (CPU) found in computing devices. Memory 130 is a non-transitory storage device for storing computer code for execution by processor 120, and also for storing various data and parameters. As shown in FIG. 1, memory 130 includes audio 131 and executable code 140. Audio 131 is an audio having audio characteristics. In some implementations, audio 131 may be played by system 100. Audio 131 may be an audio file including pure sine wave audio ranging from about 20 hertz to about 180 hertz. In other implementations, audio 131 may be a pre-recorded sound, such as a voice, instruments, music, or other natural sound, human-made sound, or computer-generated sound. Audio 131 may be used by processor 120. Executable code 140 may include one or more software modules for execution by processor 120. As shown in FIG. 1, executable code 140 includes audio module 141, user interface module 143, and visualization module 145.

Audio module 141 is a software module stored in memory 130 for execution by processor 120 to play an audio signal and adjust audio characteristics of the audio signal. Audio module 141 may receive the audio signal from audio input device 103, digital audio converter 180, or from audio 131. Audio module 141 may transmit the audio signal for playing on speakers 191. In some implementations, audio module 141 may receive user input from control device 101 to adjust audio characteristics of the audio signal. Audio characteristics may include the fundamental frequency, the amplitude, the binaural tone offset for playback on mono or stereo speakers, and harmonic blending. In other implementations, audio module 141 may generate an audio for playback using system 100. System 100 may function best when the audio is in a range of about 30 Hz to 60 Hz. System 100 may operate using frequencies above and below this range based on user preferences, such as the user's auditory comfort and the user's physical/vibrational comfort. The user may be able to adjust one or more of the audio characteristics of the audio signal to affect the immersive cymatic experience.

User interface module 143 is a software module stored in memory 130 for execution by processor 120 to play audio 131 for a user to feel. User interface module 143 may control the audio for transmission to physical user interface 190. In some implementations, user interface module 143 may control the audio characteristics of the audio transmitted to physical user interface 190. User interface module 143 may align the transmission with the audio transmitted to speakers 191, or user interface module 143 may offset the frequency transmitted to physical user interface 190 to create a variance or beat with one or more of the audios transmitted to one or more of speakers 191. In some implementations, user interface module 143 may affect a user experience to physically experience audio phenomena such as binaural beats and harmonic overtones.

Visualization module 145 is a software module stored in memory 130 for execution by processor 120 to adjust visualization characteristics. In some implementations, visualization module 145 allows a user to adjust visual characteristics of system 100. In some implementations, visualization module 145 may affect the characteristics of the lighting provided by light 194, such as the hue of one or more lights, the brightness of the lights, the intensity of the lighting, or the color saturation of the lights. In some implementations, visualization module 145 may control the position of one or more lights with respect to one or more other lights, or the position of one or more lights with respect to an interference visualization element. In some implementations, visualization module 145 may control a position of a camera relative to the interference visualization element.

Visualization module 145 may include a projection mapping software for displaying an interference visualization pattern on display 196. For example, the projection mapping software may mask a portion of the signal from camera 195 so that a circular image of interference visualization element is shown on a circular display 196. In other implementations, visualization characteristics of system 100 may be adjusted through a smartphone interface or other visualization control input. Visualization module 145 may enable system 100 to mask the projected interference pattern onto a specifically shaped display screens or surface, such as a circular display. Masking out the portions of the display feed may enable system 100 that would otherwise project outside of the intended projection surface. In some implementations, visualization module 145 may also include other features, such as color adjustments, filters, and may project other imagery outside of the cymatics image mask, such as frequency, harmonic, binaural offset and volume data, or other sorts of visuals.

In some implementations, visualization module 154 may generate an interference pattern computationally. Visualization module 145 may digitally create an interference medium and may computationally generate interference patterns by modelling the interference medium, such as by using a three-dimensional (3D) mesh, a 3D fluid, 3D or two-dimensional (2D) particles, or other appropriate digital representations.

Signal processing device 180 is a processing device for converting digital signals to analog signals, converting analog signals to digital signals, and processing audio signals. Signal processing device 180 may be a digital audio converter. In some implementations, digital audio converter may add pre-processing effects to an audio signal before the signal is processed by processor 120 or post processing effects to an audio signal after processing by processor 120. Signal processing device 180 may be incorporated into computing device 110, or signal processing device 180 may be a separate device.

Physical user interface 190 is an interface allowing the user to physically experience the audio. In some implementations, physical user interface 190 may be a furniture or item upon which the user may sit or recline, such as a chair, a recliner, or a daybed. In other implementations, physical user interface 190 may be a fixture or element of a room housing system 100, such as a pillar, a counter, a fixture bench seat, the floor, or a wall. In still other implementations, physical user interface 190 may be a wearable device, such as a backpack or one or more haptic jewelries, such as haptic bracelets, haptic ankle bands, haptic shoes, or other wearable devices configured to play a frequency. Physical user interface 190 may include a motor, driver, or oscillator for driving the user interface, such as a powerful bass transducer, based on the audio.

Speaker 191 may be a speaker for playing an audio signal. In some implementations, speaker 191 may include one speaker. In other implementations, speaker 191 may include a set of two or more speakers. The speakers may be arranged at an angular separation relative to the position of the user or the position of physical user interface 190. In some implementations, the speakers may be arranged opposite each other on opposing sides of the user, such as on the right side and left side of the user. In some implementations, the speakers may be headphones, including in-ear and over-ear headphones.

Interference visualization element 193 may be a physical element to show the interference pattern or patterns resulting from various frequencies of the audio. Interference visualization element 193 may be a container partially filled with a liquid, such as a bowl of water. In other implementations, interference visualization element 193 may include a fluidic interference medium, such as sand on a drumhead or other particulate composition that behaves in a fluidic manner when placed on a vibrating surface. In some implementations, the fluidic interference medium may be macroscopic. In other implementations, the fluidic interference medium may be microscopic. With the right hardware and optics, interference patterns may form at microscopic levels.

Light 194 may be one or more light sources. In some implementations, light 194 may include a plurality of lights. The plurality of lights may include lights of different colors. For example, light 195 may include three lights, one red, one green, and one blue for creating red-green-blue (RGB) white light. In some implementations, each light of light 194 may be positioned at a location in relation to interference visualization element 193. The positions of each light may be at different locations from the other lights resulting in discrete interaction of each light, and the color thereof, with the interference element of interference visualization element 193. In some implementations, lights of light 194 may be concentric ring lights positioned perpendicularly above the interference element of interference visualization element 193. The lights may be ring lights with adjustable colors. In some implementations, there may be two concentric ring lights with adjustable red-green-blue (RGB) colors. In other implementations, there may be more than two lights, or the lights may be at one or more offset angles with respect to the interference element of interference visualization element 193.

Camera 195 may be a video camera, a streaming camera, a still camera, a digital camera, or a recording device for capturing images to be displayed to the user. In some implementations, the images may be captured and displayed in real-time. Camera 195 may capture images of an interference pattern exhibited by interference visualization element 193. Display 196 may be a display for showing the images captured by camera 195. In some implementations, display 195 may be a television display, a computer display, a projector with a screen, or other display suitable for showing still or moving images.

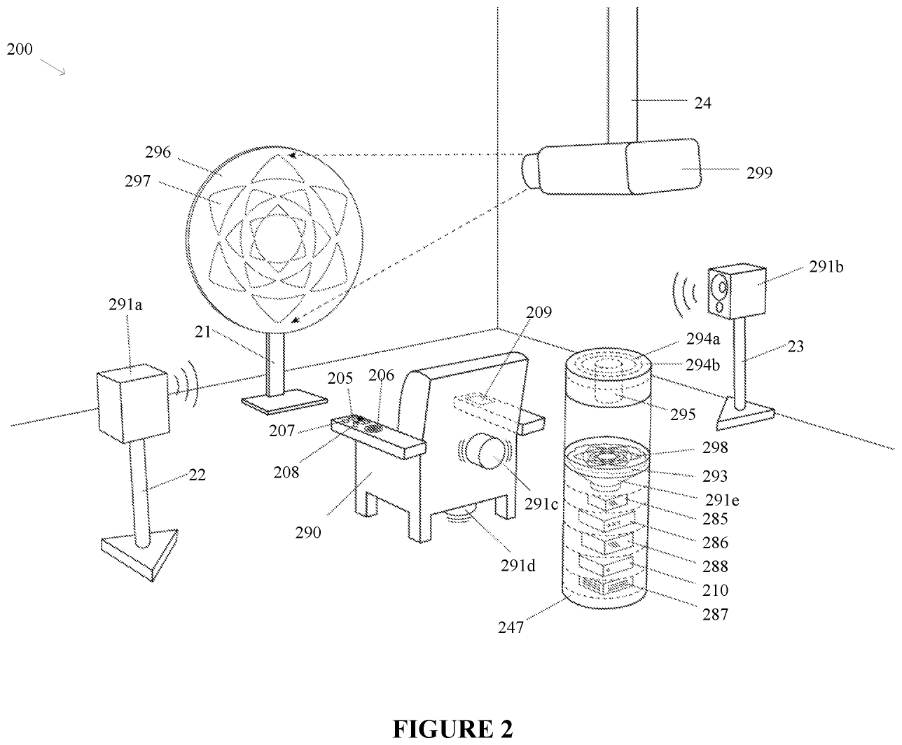

FIG. 2 shows a diagram depicting an exemplary system for creating immersive cymatic experiences, according to one implementation of the present disclosure. System 200 includes computing device 210, projector 299 projecting interference pattern 297 onto display 296, left speaker 291a, right speaker 291b, physical user interface 290 with transducer 291c attached to the back of physical user interface 290 and transducer 291d attached underneath the seat of physical user interface 290. Equipment housing 247 includes ring lights 294a and 294b with camera 295, positioned above interference visualization element 293, where interference pattern 298 is created by speaker 291e which is, in turn, driven by amplifier 285. Display 296 may be a shaped display, such as a round display, and may be supported by a display stand. As shown in FIG. 2, display 296 is supported by display stand 21.

As shown in FIG. 2, physical user interface 290 is a chair. Physical user interface 290 includes user inputs for adjusting or controlling the cymatic experience. Fader 205 may be used to adjust or control the fundamental frequency, touchpad 209 may be used as a harmonic overtone control, control 207 may be a binaural offset control, and control 208 may be a volume control. A user may experience system 200 by sitting in physical user interface 290 and activating the system. Computing device 210 may initiate physical user interface 290 activating transducer 291c and transducer 291d, initiate speaker 291e causing interference visualization element 293 to display an interference pattern, and initiate speakers 291a and 291b. Transducers 291c and 291d may be driven by transducer amplifier 286. As shown in FIG. 2, interference visualization element 293 includes fluidic interference medium 298. Fluidic interference medium 298 may create interference pattern 297 when agitated at a particular frequency. In some implementations, all components of system 200 may operate based on the frequency of the audio from computing device 210.

The user may experience the audio visually by observing interference pattern 297 on display 296. The cymatic patterns generated by fluidic interference medium 298 are captured by camera 295 suspended directly above and substantially perpendicular to fluidic interference medium 298 creating interference pattern 297 in interference visualization element 293, output to screen 296 that appears directly in front of the participant sitting in physical user interface 290. The smaller ring light 294b, mounted around the lens of camera 295, may remain a particular color or may be an adjustable-color light, while the larger variable RGB ring light 294a may have visual characteristics that can be controlled using input 206. In some implementations, adjusting the color combinations of lights 294a and 294b may have a significant impact on the overall mood of the experience created by system 200.

The user may experience the audio aurally by hearing it from speakers 291a and 291b. The sounds produced by computing device 210 may be created using audio module 141, which may be controlled by the user using inputs 205, 207, 208, and 209 on physical user interface 290. The audio may be a pure sine audio with a frequency ranging from about 20 hz-120 hz. In some implementations, the user may adjust the frequency freely with user control 205. Using the controls, the user may be able to blend together harmonics, such as the Major 3rd, Major 5th, and upper octaves of the current frequency of the audio. Additionally, the user may actuate an arcade-style button, or other user control, to add in a 0.5 hz frequency offset to generate a natural pulse using binaural beats. In other implementations, the binaural offset control may offer a range across which the user may adjust the binaural offset. In some implementations, the range may adjust the audio signal in one speaker relative to another by less than 1 Hz, about 1 Hz, or more than 1 Hz. Different binaural offsets may result in different cymatic experiences and may change the mood or tone of the user's experience.

The user may experience the audio physically or tactually through physical user interface 290, with the tactile experience driven by transducers 291c and 291d. The inclusion of vibrations in system 200 may help to create a compelling, immersive cymatic experience. Being able to deeply feel the sound that is simultaneously being heard and seen may be important to creating an impactful cymatic experience. In some implementations, equipment housing 247 may be cooled by fan 287. The audio output from computing device 210 may be processed by signal processing device 280.

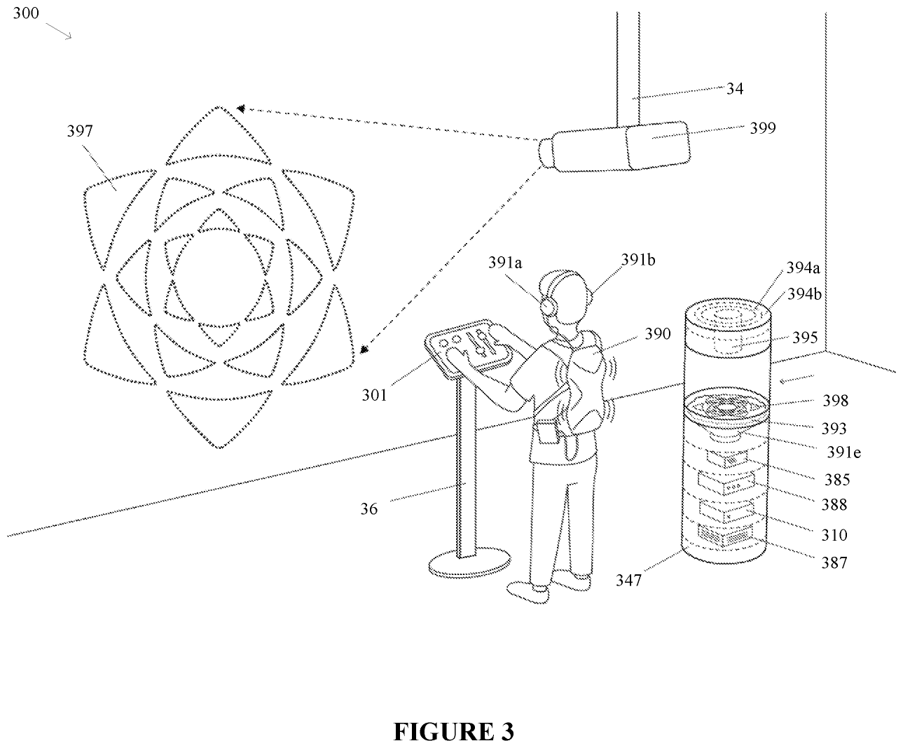

FIG. 3 shows a diagram depicting an exemplary system for creating immersive cymatic experiences, according to one implementation of the present disclosure. System 300 includes computing device 310, projector 399, supported by projector mount 34, projecting interference pattern 397 onto a wall surface or screen display, headphones including left speaker 391a and right speaker 391b, and physical user interface 390. Equipment housing 347 includes ring lights 394a and 394b with camera 395, positioned above interference visualization element 393, where interference pattern is created by speaker 391e which is, in turn, driven by amplifier 386. As shown in FIG. 3, interference visualization element 393 includes fluidic interference medium 398. Fluidic interference medium 398 may create interference pattern 397 when agitated at a particular frequency.

As shown in FIG. 3, physical user interface 390 is a backpack worn by the user, such as a haptic backpack including haptic, vibrational, or oscillating drivers to communicate the tactile experience of the audio signal played by system 300 to the user. Input device 301, supported by stand 36, includes user inputs for adjusting or controlling the audio and the cymatic experience. In some implementations, equipment housing 347 may be cooled by fan 387. The audio output from computing device 310 may be processed by signal processing device 380.

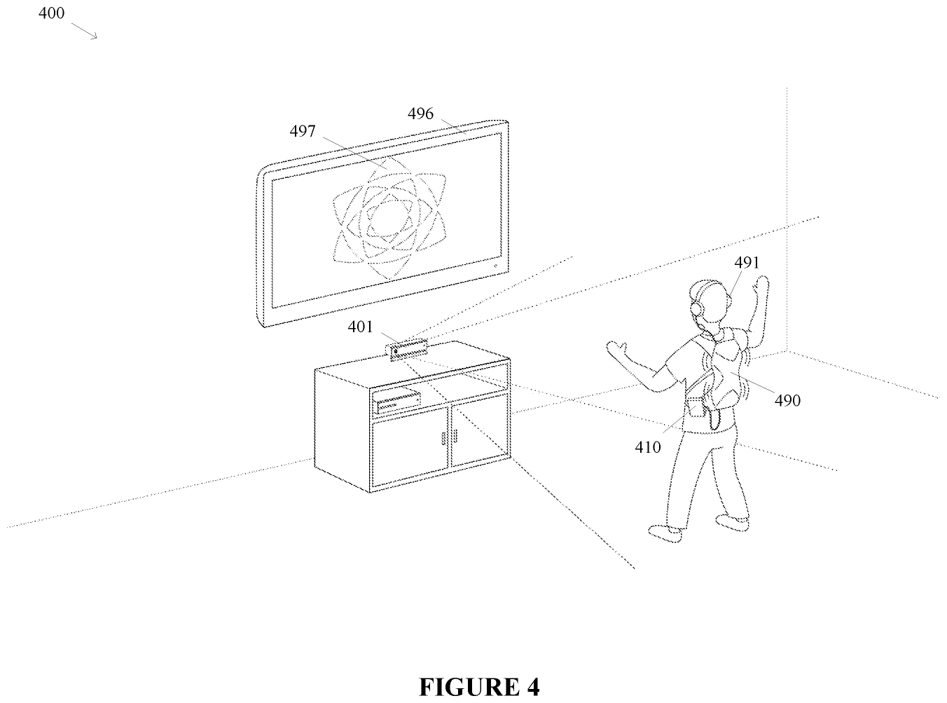

FIG. 4 shows a diagram depicting another exemplary system for creating immersive cymatic experiences, according to one implementation of the present disclosure. System 400 includes computing device 410, display 496, headphones 491, and physical user interface 490. As shown in FIG. 4, physical user interface 490 is a haptic backpack worn by the user. Input device 401 is a motion-sensor device for capturing user inputs to adjust or control the cymatic experience of system 400. In some implementations, system 400 may computationally generate create interference pattern 497. System 400 may generate interference pattern 497 without a ring light, interference visualization element, or fluidic interference medium. Interference pattern 497 may be computationally generated by visualization module 145 and shown on display 496. Computing device 410 may be wirelessly connected to display 496. In other implementations, system 400 may be implemented with these components, instead.

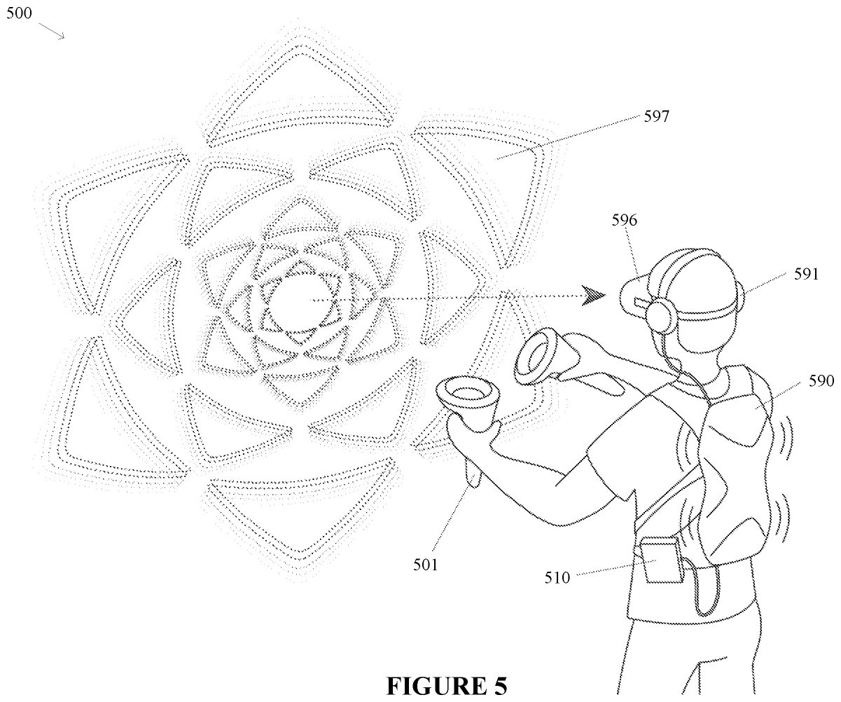

FIG. 5 shows a diagram depicting another exemplary system for creating immersive cymatic experiences, according to one implementation of the present disclosure. System 500 includes computing device 510, virtual reality headset display 596, headphones 591, and user interface 590. As shown in FIG. 5, physical user interface 590 is a haptic backpack worn by the user. Input device 501 is a set of virtual reality controls for capturing user inputs to adjust or control the cymatic experience of system 500. Interference pattern 597 is visible to the user on virtual reality headset 596. In some implementations, system 500 may computationally generate create interference pattern 597. System 500 may generate interference pattern 597 without a ring light, interference visualization element, or fluidic interference medium. Interference pattern 597 may be computationally generated by visualization module 145 and shown on display 596. In other implementations, system 500 may be implemented with these components, instead.

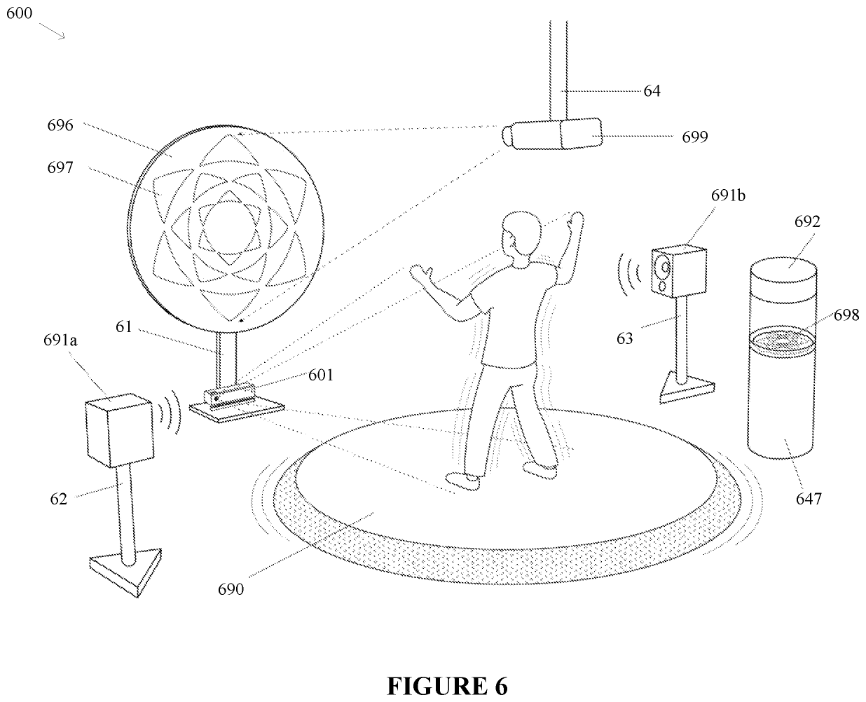

FIG. 6 shows a diagram depicting another exemplary system for creating immersive cymatic experiences, according to one implementation of the present disclosure. System 600 includes projector 699, supported by projector mount 64, projecting interference pattern 697 onto display 696, speaker 691a supported by stand 62 and right speaker 691b supported by stand 63, and physical user interface 690. As shown in FIG. 6, physical user interface 690 is a floor activated by haptic motors or bass transducers (not shown). Equipment housing 647 includes light and camera compartment 692, fluidic interference medium 698 creating interference pattern 697. Input device 601 captures motions of the user to adjust the cymatic experience of system 600.

In some implementations, the systems disclosed herein may be implemented in various installations. Three-dimensional illustrations of additional installation possibilities are included in the appendix.

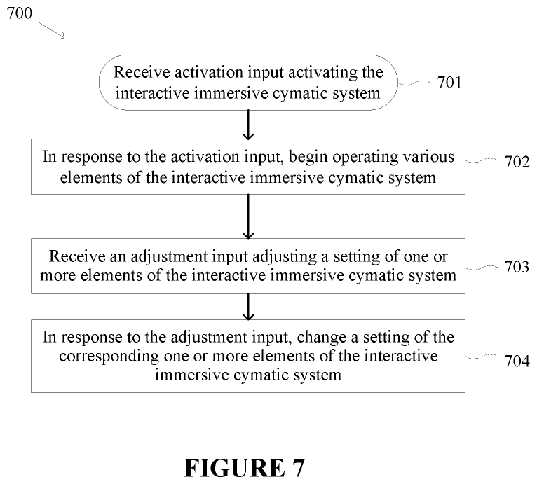

FIG. 7 shows a flowchart illustrating an exemplary method of creating immersive cymatic experiences, according to one implementation of the present disclosure. Method 700 begins at 701 where processor 120 receives an activation input activating system 100. At 702, in response to the activation input, processor 120 may initiate operation of various elements of system 100. Processor 120 may activate one or more of physical user interface 190, speakers 191, interference visualization element 193, lights 194, camera 195, or display 196. Activated system 100 may initiate physical user interface 190 and, optionally, speakers 191. In some implementations, physical user interface 190 and speakers 191 will oscillate or vibrate at the same frequency. In some implementations, the activation input may also initiate vibration, agitation, or oscillation of the interference visualization element 193. Interference visualization element 193 may operate at the same frequency as the physical user interface and the speaker. In some embodiments, each element of system 100 operates at the same frequency of oscillation. In other embodiments, the elements of the system may operate at different frequencies. The different frequencies may be complimentary frequencies, or they may be dissonant frequencies.

At 703, Receive an adjustment input adjusting a setting of one or more elements of system 100. In some implementations, the adjustment input may adjust an audio characteristic of system 100. The audio characteristics may be characteristics of the audio generated by audio module 141. The audio characteristics may include an amplitude or volume of the audio, a fundamental frequency of the audio, a secondary frequency of the audio, a binaural tone offset of the audio, and a harmonic blending of the audio. By adjusting the volume or amplitude of the audio, the user increases or decreases the amplitude of the signal passing through physical user interface 190, speakers 191, or interference visualization element 193. This may allow greater user control and fine tuning of the shapes of the live-generated cymatic interference patterns exhibited by interference visualization element 193 and shown on display 196. In some implementations, a frequency experienced at different volumes will yield subtle differences in the user experience. In other implementations, the same frequency experienced at different volumes will yield more significant differences in the user experience.

In some implementations, audio module 141 may auto-manage the volume or amplitude output levels transmitted to interference visualization element 193 in an inverse relationship to the primary frequency, in order to maintain a balanced signal level that will successfully generate symmetrical cymatic patterns in interference visualization element 193. A delicate balance between frequency and amplitude is required. Too little amplitude may result in no interference pattern activity; too much amplitude may lead to chaotic activity in interference visualization element 193. Excessive amplitude may result in splashing, overflow, or other malfunction of interference visualization element 193.

In some implementations, lower frequencies of the audio may require greater amplitude to generate interference activity in interference visualization element 193. Higher frequencies may require a lower amplitude to generate interference activity in interference visualization element 193. If the same amplitude were used for all frequencies, the lower range would not produce wave activity while the higher range would result in chaotic wave activity and splashing out of the water dish. Frequencies in the middle range would likely generate well balanced geometric patterns.

The volume or amplitude controls may be offered as adjustable to the user or users in different ways depending on the particular setup of the project for each use case. For a seated user or multiple users on a vibrating chair or couch, control device 101 may include a simple slider, a knob to turn, a touchpad, or touchscreen, all as part of the arms of the seat, a joystick of a handheld game pad, or motion-sensor hand/arm gesture controls, among other possibilities.

In the case of a standing user or users in a wearable or haptic version of physical user interface 190, or when physical user interface 190 is a vibrating platform surface, such as the floor, or other element of system 100, control device 101 may be a touchscreen interface positioned on a raised podium, a joystick of a handheld game pad or a touch interface of custom design that can be passed among multiple users, or motion-sensor hand/arm gesture input, among other possibilities.

In the case of a user or multiple users lying down on a vibrating bed, platform, or surface, control device 101 may be a joystick of a handheld game pad or a touch interface of custom design that can be passed among multiple users, or motion-sensor hand/arm gesture input, among other possibilities.

In some implementations, the adjustment input may change a frequency of one or more elements of system 100. In some implementations, system 100 may allow the user to change the operating frequency through a spectrum of operating frequencies such that there is a smooth transition through each frequency across the spectrum. In other implementations, the system may allow the user to change frequencies in a stepwise manner. For example, the user interface for receiving user input changing the operating frequency of the system may be incremented to allow the user to select from a limited number of preset operational frequencies.

In other implementations, the audio characteristics may include the fundamental frequency of the audio. The fundamental frequency may be a sine wave frequency within a limited range, from 40 Hz to 60 Hz, 30 Hz to 70 Hz, 20 Hz to 80 Hz, or 10 Hz to 120 Hz, a combination of these frequency ranges, subranges of these frequency ranges, or other appropriate frequency range. The frequency range may be selected with the participant's audible and physical/vibrational comfort in mind. In some implementations, the appropriate fundamental frequency may be affected by a space in which system 100 operates. In some implementations, system 100 may receive audio input including other sounds, such as recorded music, live music, input form musical instruments or microphones capturing audio of instruments, singing, talking, pre-recorded sounds, such as sounds from nature, etc.

In some implementations, there may be more than one user. The audio signal may include a plurality of audio elements, such as an audio signal including a melodic element, a vocal element, and a rhythmic element. One or more users of system 100 may have a control affecting one of the audio elements. Each user may have interactivity to control a different aspect or element of an audio signal that includes a plurality of audio elements.

Control device 101 may include a control for adjusting individual aspects of the audio. In some implementations, control device 101 may include a fundamental frequency control. The fundamental frequency control can be variable/changeable, depending on the particular setup of the project for each use case. For example, when the user is in a seated position, such as sitting on a vibrating chair or couch, fundamental frequency controls may include a simple slider, a knob to turn, a touchpad or touchscreen, all as part of the arms of the seat, a joystick/buttons of a handheld game pad, or motion-sensor hand/arm gesture controls, among other possibilities.

As another example, when the user is in a standing position utilizing a wearable or haptic version of physical user interface 190, or when physical user interface 190 is a vibrating platform surface, such as the floor, or other element of system 100, fundamental frequency controls may be a touchscreen interface raised on a podium, a joystick/buttons of a handheld game pad or a touch interface of custom design that can be passed among multiple users, or motion-sensor hand/arm gesture/full body movement and position input, among other possibilities.

As another example, when the user is lying down on a vibrating bed or platform, fundamental frequency controls may include a joystick/buttons of a handheld game pad or a touch interface of custom design that can be passed among multiple users, or motion-sensor hand/arm gesture input, among other possibilities.

In some implementations, control device 101 may include a harmonic overtone control. The harmonic overtone control may be used to adjust the harmonic overtone blending of the audio. Harmonic overtone pitches may consist of sets of relative major and minor scale pitches, and may be in tune with changing primary frequency, including an upper octave that can raise the overall pitch to 160 hz or greater. Users can single out one harmonic overtone to blend in, or blend in more than one at one time from the selection made available. Keeping the harmonic overtones in tune with the fundamental frequency may keep the cymatic experience from becoming chaotic or potentially dark in mood or tone. Producing only the major 3rd, 5^{th}, and octave of the fundamental frequency, for example, consistently results in uplifting tones that naturally resolve musically. In other implementations, the user may select tones that are not in tune with the fundamental frequency, allowing the user to experience the cymatic experience of discordant audio signals. Such discordant tones may have a different effect on the elements of system 100, such as interference visualization element 193, and may affect the user's visual, aural, and physical experience, and may impact the emotional experience of the user.

The harmonic overtone blending input controls may be variable/changeable, depending on the particular setup of the project for each use case. For example, when the user is in a seated position, the harmonic overtone controls may include a simple slider, a knob to turn, a touchpad or touchscreen, all as part of the arms of the seat, a joystick/buttons of a handheld game pad, or motion-sensor hand/arm gesture controls, among other possibilities.

As another example, when the user is in a standing position utilizing a wearable or haptic version of physical user interface 190, or when physical user interface 190 is a vibrating platform surface, such as the floor, or other element of system 100, harmonic overtone controls may be a touchscreen interface raised on a podium, a joystick/buttons of a handheld game pad or a touch interface of custom design that can be passed among multiple users, or motion-sensor hand/arm gesture or full body movement and position input, among other possibilities.

As another example, when the user is lying down on a vibrating bed or platform, harmonic overtone controls may be a joystick/buttons of a handheld game pad or a touch interface of custom design that can be passed among multiple users, or motion-sensor hand/arm gesture input, among other possibilities.

In some implementations, control device 101 may include a binaural offset control. The binaural blend of an audio may slightly offset one or more frequencies by about −1 hz to +1 hz relative to the primary frequency. A slight variance in waveforms between left and right channels may naturally generate binaural beats. One of the audio channels, either the left or the right, may be used for this offset frequency. The binaural offset control may be variable/changeable, depending on the particular setup of the project for each use case. For example, when the user is in a seated position, such as sitting on a vibrating chair or couch, binaural offset controls may include a simple slider, a knob to turn, a touchpad or touchscreen, all as part of the arms of the seat, a joystick of a handheld game pad, or motion-sensor hand/arm gesture controls, among other possibilities.

As another example, when the user is in a standing position utilizing a wearable or haptic version of physical user interface 190, or when physical user interface 190 is a vibrating platform surface, such as the floor, or other element of system 100, binaural offset controls may include a touchscreen interface raised on a podium, a joystick of a handheld game pad or a touch interface of custom design that can be passed among multiple users, or motion-sensor hand/arm gesture input, among other possibilities.

As another example, when the user is lying down on a vibrating bed or platform, binaural offset controls may be a joystick of a handheld game pad or a touch interface of custom design that can be passed among multiple users, or motion-sensor hand/arm gesture input, among other possibilities. In some implementations, the adjustment input may adjust a visual characteristic of system 100.

At 704, In response to the adjustment input, change a setting of the corresponding one or more elements of system 100. In response to the user input, system 100 may change the frequency of one or more elements of the system. For example, the user may increase the operating frequency of the system. In response to the user input, the system may increase the operating frequency of the physical user interface, the interference pattern visualization element, and the speaker. This change in frequency may be instantaneous or gradual. For example, if the user increased the frequency from 20 Hz to 30 Hz, the system may instantaneously change from 20 Hz to 30 Hz, or the change may be a linear increase from 20 Hz to 30 Hz over a time, such as one second or five seconds. System 100 may operate at the user-selected frequency. The user may make a subsequent change to the operating frequency of the system. In some embodiments, the user may experience many settings and explore various physical and mental effects of different frequencies.

In some implementations, interference pattern 298 may be generated computationally. Interference visualization element 193 may be digitally created using visualization module 145 and may computationally generate interference patterns by computation, by modelling an interference medium, such as by using a 3D mesh, a 3D fluid, 3D or two-dimensional (2D) particles, or other appropriate digital representations.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system having a speaker playing an audio having a frequency, a display showing an interference pattern based on the frequency, and a vibrational user interface for providing a tactile experience to a user based on the frequency.

2. The system of claim 1, further comprising a control device including a user control, a non-transitory memory storing an executable code, and a hardware processor executing the executable code to:
receive an input from the user control; and
adjust an audio characteristic of the audio in response to the input.

3. The system of claim 2, wherein the audio characteristic is one of a fundamental frequency of the audio, a secondary frequency of the audio, a volume of the audio, a beat frequency of the audio, a binaural tone offset of the audio, and a harmonic blending of the audio.

4. The system of claim 1, further comprising a control device including a user control and a light providing a lighting illuminating an interference medium creating the interference pattern, a non-transitory memory storing an executable code, and a hardware processor executing the executable code to:
receive an input from the user control; and
adjust a visual characteristic of the interference pattern displayed on the display in response to the input.

5. The system of claim 4, wherein the visual characteristic is one of an intensity of the lighting, a hue of the lighting, and a saturation of the lighting.

6. The system of claim 1, further comprising a control device including a user control, a non-transitory memory storing an executable code, and a hardware processor executing the executable code to:
receive an input from the user control; and
adjust a vibrational characteristic of the vibrational user interface in response to the input.

7. The system of claim 6, wherein the vibrational characteristic is one of a fundamental frequency and a secondary frequency.

8. A method for use with a system including a pair of speakers, an interference visualization element, and a vibrational user interface, the method comprising:
playing a sound having a frequency through the pair or speakers;
displaying an interference pattern based on the frequency of the sound on a display, the interference pattern shown by the interference visualization element; and
driving a transducer based on the frequency of the sound to activate the vibrational user interface.

9. The method of claim 8, further comprising:
receiving a user input from a control device; and
adjust one of an audio characteristic of the sound and a vibrational characteristic of the vibrational user interface in response to the input.

10. The method of claim 8, wherein the system further comprises two or more lights, each light having a corresponding color wherein each of the two or more lights has a different color, the two or more lights lighting the interference visualization element creating a multi-color interference pattern for display on the display.

11. The method of claim 10, further comprising:
receiving a user input from a control device; and
adjusting a visual characteristic of the interference pattern displayed on the display in response to the input.

12. The method of claim 11, wherein the visual characteristic is one of an intensity of the lighting, a hue of the lighting, and a saturation of the lighting.
